(19) United States
(12) Patent Application Publication
(10) Pub. No.: US 2006/0065738 A1
(43) Pub. Date: Mar. 30, 2006

(54) RFID DEVICE AND METHOD OF MANUFACTURE

(76) Inventors: Ronald James Versic, Oakwood, OH (US); Robert E. Ramsey, Kettering, OH (US)

Correspondence Address: A PATENT LAWYER CORP, PC;R WILLIAM GRAHAM, 22 S ST CLAIR ST, DAYTON, OH, 45402, US

(21) Appl. No.: 10/711,709

(22) Filed: Sep. 30, 2004

(51) Int. Cl. G06K 19/06

(52) U.S. Cl. 235/492

(57) ABSTRACT

A method of making an RFID device which includes the steps of (a) applying a UV curable adhesive having electrically conductive particles therein to a pair of laterally displaced landing sites of antenna formed on a UV penetrable web in a manner such that the particles remain spatially positioned from one another, (b) bringing a pair die pads of a die into sufficient electrical contact with the landing sites to effect a Z axis conductivity through the particles between a respective die pad and landing site pad pair while precluding X-Y conductivity between the landing site pads, and (c) UV irradiating of the adhesive through and/or about the web in a manner to cure the adhesive join the die to the antenna. An RFID device is also provided by the process.

### BACKGROUND OF THE INVENTION

1. Field of the Invention

The invention relates to radio frequency identification (RFID) labels, more particularly the invention relates to an RFID device and method of making the same.

2. Prior Art

RFID devices are known in the art, such as disclosed in U.S. Pat. Nos. 5,347,263. These devices are used in systems for product identification, access control, inventory control, process control, and security applications, for example.

A typical RFID system has a passive RFID label with an antenna and chip circuitry therein and a separate RFID reader/writer. The RFID reader/writer energizes the RFID label circuitry by transmitting a power signal. The power signal may convey data which is stored in memory incorporated in the RFID label circuitry. In response to the power signal the RFID label circuitry may transmit a response signal containing data stored in memory thereof. The RFID reader/writer receives the response signal and interprets the data contained therein. The data is then transmitted to a host computer for processing.

There are several ways these RFID labels have been made. For example, a laminated label is formed with a first conductive material having electrical attachment pads and a dielectric material surrounding the attachment pads. A second conductive material is deposited on the dielectric material and an antenna is electrically connected to the attachment pads. A layer of expandable material forms a protective cavity surrounding the attachment pads. An integrated circuit (IC) chip is received in the protective cavity and connected to the antenna. The RFID label can be printed with a conductive material in a pattern to form antennae onto a substrate. The conductive material may be printed using silk screening techniques, such as in a sheet fed or roll operation.

In one case, each antenna is die cut into individual pieces. Each piece is placed in a carrier where an integrated circuit (IC) chip, such as a flip chip, is electrically connected to the antenna using conventional chip attachment methods. The chip is then encapsulated in an epoxy material and the entire assembly is sandwiched between protective layers. Once the individual antennae are die cut into individual pieces, each piece must be loaded into a carrier for subsequent processing. A window can be cut into the substrate to accommodate the chip and encapsulating material.

While these current RFID labels have met with some success, the prior labels have drawbacks in their manner and expense of manufacture as well as utility. Prior label designs fail to provide an inexpensive manner of making an RFID label with satisfactory operability.

### BRIEF SUMMARY OF THE INVENTION

It is an object of the invention to improve RFID devices.

It is another object to improve the method of making an RFID.

It is yet another object to provide a more efficient RFID device.

Accordingly, one aspect of the present invention is directed to a method of making an RFID device which includes the steps of:
(a) applying a UV curable adhesive having electrically conductive particles therein to a pair of laterally displaced landing sites of antenna formed on a UV penetrable web in a manner such that the particles remain spatially positioned from one another,
(b) bringing a pair die pads of a die into sufficient electrical contact with the landing sites to effect a Z axis conductivity through the particles between a respective die pad and landing site pad pair while precluding X-Y conductivity between the landing site pads, and
(c) UV irradiating of the adhesive through and/or about the web in a manner to cure the adhesive join the die to the antenna.

The UV curing can take place beneath the web. Further, an inert gas, such as nitrogen, may be used to rid oxygen from the surface of the adhesive around the die during the process.

An RFID device is provided by the process. Particularly, an RFID device includes:
a UV penetrable substrate;
an antenna adhered to said substrate having a landing site extending therefrom;
a die chip having a die pad extending therefrom which is disposed adjacent said antenna; and
a UV cured adhesive having a electrically conductive particles dispersed therethrough in a manner to only provide electrical conductivity between the landing site and the die pad, and wherein the adhesive bonds the die chip and the antenna.

The foregoing and other objects and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a side schematic view depicting the making of an RFID label according to the present invention.

FIG. 2 is a top view of an RFID device of the invention.

### DETAILED DESCRIPTION OF THE PREFERRED EMBODIMENTS

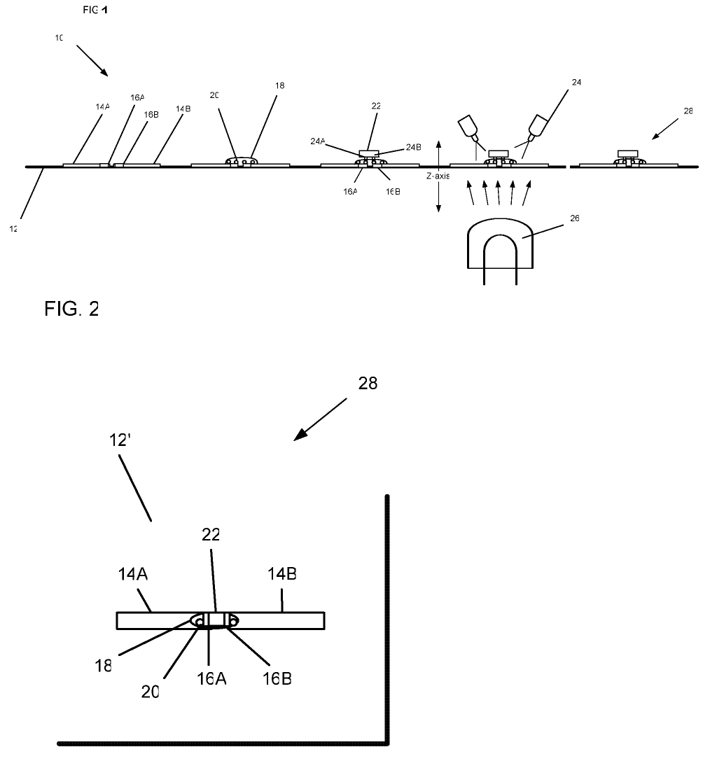

Referring now to FIG. 1, a process for forming an RFID label according to the invention is generally designated by the numeral 10. A substrate 12 is provided which can be in the form of a web. The substrate 12 can preferably be a transparent material to a curing radiation such as a clear polymer material, e.g., clear Mylar (polyester).

Antenna leads 14A and 14B can be formed onto the substrate 12. The antenna leads 14A and 14B can be an electrically conductive material deposited onto the substrate 12 in a manner as is known in the art. For example, a metallic conductive ink can be deposited using silk screening using a silver paste, or other methods known in the art for depositing an electrically conductive material, such as electro deposition, hot stamping, etching or the like.

A pair of landing sites 16A and 16B can be formed as part of the antenna leads 14A and 14B, respectively, wherein each site 16A and 16B is likewise printed in a manner similar to the formation of the antenna leads 14A and 14B, wherein the antenna leads 14A and 14B do not contact each other. To the landing sites 16A and 16B is added a UV curable polymer nonconductive adhesive 18 which includes a plurality of electrically conductive spheres 20, such as gold coated spheres. This adhesive 18 can be added using a needle dispenser as is known to the art.

The adhesive 18 can preferably be of a mid-range viscosity having relatively rapid cure rates. Clear UV adhesives such as Dymax 3069 available from Dymax Corporation, 51 Greenwoods Rd, Torrington, Conn. and Rad-Cure 3005A available from Rad-Cure Corporation, 9 Audrey Place Fairfield, N.J. are found to be suitable. The electrically conductive spheres 20 are preferably a spherical particle in the range of 2 to 10 microns and include a divinyl benzene core with a gold plating.

The amount of particles should be such to enable the conductivity to take place in the Z axis direction as described hereinafter. To this end, a suitable formulation should include in a range of between 1-30 volume percent of electrical conductive particles 20 and 70-99 volume percent of adhesive 18. Preferred formulation ranges includes between about 6-8 volume percent of electrically conductive particles. Thus a suitable UV curable—adhesive material can be formed.

An integrated circuit (IC) chip 22 (otherwise referred to as a die chip) includes a pair of landing pads 24A and 24B for IC chip 22 attachment, wherein the pads 24A and 24B are brought into contact with spheres 20 which provide a Z-axis conductivity between the pads 24A and 24B and landing pads 16A and 16B, but not provide for X-Y conductivity therebetween. Thus, a cross over pass electrically connects each respective pair of sites/pads 16A and 24A and 16B and 24B thereby preventing shorting out antenna leads 14A and 14B. It is contemplated that more than two pairs of landing pads can be used for connecting to the IC chip 22 without departing from the scope of the present invention. The IC chip 22 includes a memory which contains data that can be communicated to an RFID reader device as is known in the art.

Once the IC chip 22 is so disposed, the UV curable adhesive 18 is subjected to a UV curing light source 26. The wavelength for curing can be in the range of 200 to 400 nm. Suitable UV wavelengths for the formulations tested have been found in the mid 300 nm range. Here, the transparent substrate 12 permits the curing to take place of the adhesive 18. It is also noted that the adhesive described does not substantially shrink which is important for maintaining a solid bond between the components.

Additionally, there is provided an inert gas 24 which is preferably vigorously blown over the adhesive 18 during the curing process to rid oxygen from the surface area of the adhesive. This enables a full curing of the adhesive 18, wherein the presence of oxygen is believed to deter the UV curing process. The exposure time required is in seconds, preferably less than 10, for a suitable formulation. Thus, an RFID device 28 is provided by cutting off a portion 12′ of the substrate 12 once the curing has taken place.

The pattern of the antenna leads 14A and 14B can preferably be such as to readily permit the ability of the UV light to reach and expose the material UV curable adhesive 18. FIG. 2 shows a top view of the formed RFID device 28.

Due to the nature of the small size of the components, a telescopic camera is employed to facilitate the manufacturing process described herein. It is to be noted that the dimensions of the various components shown and described herein are illustrative only and are not intended to represent the actual sizes of any one component. It is realized that there has been shown and described what are at present considered the preferred embodiment of the invention, it will be obvious to those skilled in the art that various changes and modifications can be made therein without departing from the scope of the invention defined by the appended claims.

What is claimed is:

1. A method of making an RFID device which includes the steps of:
(a) applying a UV curable adhesive having electrically conductive particles therein to a pair of laterally displaced landing sites of an antenna formed on a UV penetrable web in a manner such that said particles remain spatially positioned from one another,
(b) bringing a pair die pads of a die into sufficient electrical contact with said landing sites to effect a Z axis conductivity through the particles between a respective die pad and landing site pad pair while precluding X-Y conductivity between the landing site pads, and
(c) UV irradiating of the adhesive in a manner to cure said adhesive joining said die to said antenna.

2. The method of claim 1, which further characterizes the step (a) wherein said particles are metallic coated spheres.

3. The method of claim 1, which further characterizes the step (c) to include introducing an inert gas into an area surrounding an exposed portion of said adhesive.

4. The method of claim 1, which further characterizes the step (c) to include irradiating through the web.

5. An RFID device made in accordance with the method of claim 1.

6. An RFID device, which includes:
a UV penetrable substrate;
an antenna adhered to said substrate having a landing site extending therefrom;
a die chip having a die pad extending therefrom which is disposed adjacent said antenna; and
a UV cured adhesive having electrically conductive particles dispersed therethrough in a manner to only provide electrical conductivity between said landing site and said die pad, and wherein said adhesive bonds said die chip and said antenna.
